(19) United States
(12) Patent Application Publication
(10) Pub. No.: US 2024/0356166 A1
(43) Pub. Date: Oct. 24, 2024

(54) SECONDARY BATTERY MODULE AND SECONDARY BATTERY INCLUDING THE SAME

(71) Applicant: Standard Energy Inc., Daejeon (KR)

(72) Inventors: Dongyoung LEE, Daejeon (KR); Sanghyun Park, Daejeon (KR)

(21) Appl. No.: 18/641,720

(22) Filed: Apr. 22, 2024

(30) Foreign Application Priority Data
Apr. 21, 2023 (KR) 10-2023-0052434

(51) Int. Cl. H01M 50/507; H01M 50/264; H01M 50/512; H01M 50/588

(52) U.S. Cl. CPC H01M 50/507; H01M 50/264; H01M 50/512; H01M 50/588

(57) ABSTRACT

Disclosed are a secondary battery module in which metal ions dissolved in an electrolyte are oxidized and reduced to charge and discharge the module, and a secondary battery including the same. The secondary battery module includes a stack of a plurality of layers stacking in one direction, wherein a redox reaction occurs in each layer, and a pair of busbars respectively disposed on both opposing side surfaces of the stack of the plurality of layers so as to electrically connect the plurality of layers to each other in a parallel manner.

### CROSS-REFERENCE TO RELATED APPLICATION

This application claims priority from Korean Patent Application No. 10-2023-0052434 filed on Apr. 21, 2023 in the Korean Intellectual Property Office, and all the benefits accruing therefrom under 35 U.S.C. 119, the contents of which in its entirety are herein incorporated by reference.

### BACKGROUND

### Field

The present disclosure relates to a secondary battery module and a secondary battery including the same. More specifically, the present disclosure relates to a secondary battery module in which metal ions dissolved in an electrolyte are oxidized and reduced to charge and discharge the module, and a secondary battery including the same.

### Description of Related Art

Unlike existing secondary batteries, a redox secondary battery is a system in which an active material in the electrolyte is oxidized and reduced to charge and discharge the battery and is an electrochemical storage device that stores electrical energy as the chemical energy of an electrolyte solution. A conventional redox flow battery operates by continuously circulating the electrolyte in a tank inside a stack using a pump and causing an electrochemical reaction in the stack. The redox flow battery has a space limitation and a design difficulty due to the tank and the pump. Inventors of the present disclosure have developed a redox secondary battery free of the tank and the pump. However, in order to increase energy storage capacity, a plurality of stacks should be used, and accordingly, efficient electrical connection between the plurality of stacks is required.

### SUMMARY

A purpose of the present disclosure is to provide a secondary battery in which efficient electrical connection between a plurality of modules (stacks) is achieved.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A first aspect of the present disclosure provides a secondary battery module comprising: a stack of a plurality of layers stacking in one direction, wherein a redox reaction occurs in each layer; and a pair of busbars respectively disposed on both opposing side surfaces of the stack of the plurality of layers so as to electrically connect the plurality of layers to each other in a parallel manner.

In one embodiment of the secondary battery module, the plurality of layers respectively include a plurality of metal current collectors through which electrons migrate under the redox reaction, wherein one of the pair of busbars electrically connects some of the plurality of metal current collectors to each other, while the other thereof electrically connects the others of the plurality of metal current collectors to each other.

In one embodiment of the secondary battery module, the plurality of layers respectively include a plurality of metal current collectors through which electrons migrate under the redox reaction, wherein each of the pair of busbars has a plurality of busbar slits defined therein into which portions of the plurality of metal current collectors inserted, respectively.

In one embodiment of the secondary battery module, the plurality of busbar slits are arranged in a stacking direction of the plurality of layers.

In one embodiment of the secondary battery module, each of the plurality of metal current collectors has a protrusion protruding therefrom outwardly beyond a side surface of the stack of the plurality of layers, wherein each protrusion is inserted into each busbar slit.

In one embodiment of the secondary battery module, the protrusion is joined to the busbar.

In one embodiment of the secondary battery module, the protrusion is bent along a contact line between the busbar slit and the protrusion such that the protrusion faces and contacts an outer surface of the busbar.

In one embodiment of the secondary battery module, each of the pair of busbars has a busbar wing protruding therefrom and beyond one side surface of the stack of the plurality of layers, wherein the plurality of busbar slits are formed in one of both opposing side ends of each of the pair of busbars, while the busbar wing constitutes the other of the both opposing side ends of each of the pair of busbars.

In one embodiment of the secondary battery module, each of the pair of busbars has a plurality of busbar fastening holes defined in the busbar wing for fastening the busbar using blots.

In one embodiment of the secondary battery module, in each of the pair of busbars, the busbar wing is positionally opposite to the plurality of busbar slits in a direction perpendicular to the one direction.

In one embodiment of the secondary battery module, in each of the pair of busbars, a vertical length of the busbar wing is smaller than a vertical length of the stack of the plurality of layers.

In one embodiment of the secondary battery module, each of the pair of busbars covers an entirety of a corresponding side surface of the stack of the plurality of layers.

In one embodiment of the secondary battery module, a vertical length of each of the pair of busbars is larger than a vertical length of the stack of the plurality of layers.

In one embodiment of the secondary battery module, each of the pair of busbars has a maximum width greater than a width of a corresponding side surface of the stack of the plurality of layers.

In one embodiment of the secondary battery module, an area size of a side surface of each of the pair of busbars is larger than an area size of a corresponding side surface of the stack of the plurality of layers.

In one embodiment of the secondary battery module, the secondary battery module further comprises a pair of end plates respectively disposed on both opposing ends in a stacking direction of the plurality of layers, wherein a top and a bottom of each of the pair of busbars are respectively in contact with the pair of end plates.

In one embodiment of the secondary battery module, each of the pair of end plates has both opposing side flat surfaces on which the pair of busbars are disposed, respectively.

In one embodiment of the secondary battery module, a vertical level of an upper end of each busbar is lower than a vertical level of an upper end of an upper end plate disposed on an upper end of the stack of the plurality of layers, wherein a vertical level of a lower end of each busbar is higher than a vertical level of a lower end of a lower end plate disposed under a lower end of the stack of the plurality of layers.

In one embodiment of the secondary battery module, the secondary battery module further comprises a band wrapping and fastening the stack of the plurality of layers, wherein the band is disposed on both opposing side surfaces of the stack of the plurality of layers on which the pair of busbars are not disposed.

In one embodiment of the secondary battery module, each of the pair of busbars has an insulator attached or applied to a surface thereof facing a corresponding side surface of the stack of the plurality of layers.

A second aspect of the present disclosure provides a secondary battery comprising: a plurality of secondary battery modules arranged densely in one direction, wherein each of the plurality of secondary battery modules includes: a stack of a plurality of layers stacking in one direction, wherein a redox reaction occurs in each layer; and a pair of busbars respectively disposed on both opposing side surfaces of the stack of the plurality of layers so as to electrically connect the plurality of layers to each other in a parallel manner, wherein respective busbars of two adjacent secondary battery modules among the plurality of secondary battery modules are electrically connected to each other.

In one embodiment of the secondary battery, a secondary battery further comprises a plurality of busbar connection means for electrically connecting the two adjacent secondary battery modules among the plurality of secondary battery modules to each other in a series manner.

In one embodiment of the secondary battery, each of the pair of busbars has a busbar wing as one side end thereof, wherein the busbar wing protrudes outwardly beyond a side surface of the stack of the plurality of layers, wherein the plurality of busbar connection means physically and electrically connect respective busbar wings of respective busbars of the two adjacent secondary battery modules to each other.

In one embodiment of the secondary battery, each of the pair of busbars has a plurality of busbar fastening holes defined therein through which the plurality of busbar connection means pass through, respectively.

In one embodiment of the secondary battery, each busbar connection means passes through the busbar in a direction in which the plurality of secondary battery modules are arranged.

In one embodiment of the secondary battery, the respective busbars of the two adjacent secondary battery modules partially protrude outwardly beyond a side surface of the stack of the plurality of layers such that the protrusions thereof are connected to each other.

Details of other embodiments are included in the detailed description and drawings.

The technical solutions according to the embodiment of the present disclosure are not limited to the solutions mentioned above, and other solutions not mentioned will be clearly understood by those skilled in the art from the description below.

According to the present disclosure, the secondary battery module and the secondary battery including the same have one or more of following effects.

First, the plurality of slits may be defined in the busbar that connects the plurality of layers to each other in a parallel manner. Thus, the busbar may be simply connected to the plurality of metal current collectors.

Second, the respective busbars of the two secondary battery modules may be connected to each other, thereby simply connecting the two secondary battery modules to each other electrically and physically.

Third, the busbar may partially protrude outwardly beyond the stack of the layers such that the two busbars may be simply connected to or disconnected from each other via the protrusions, and smooth heat dissipation of the busbar may be achieved via the protrusion.

Fourth, a portion of the busbar to which an external power source or an external electric load is connected and a portion of the busbar to which the metal current collector is connected positionally correspond to each other in the horizontal direction, but are spaced apart from each other, so that the flow of electricity is smooth, and deviation between currents of the plurality of layers does not occur.

Fifth, the portion of the busbar to the metal current collector is connected and a portion via which the busbars are connected to each other in series are designed appropriately, thereby achieving high energy efficiency and low heat generation.

Effects of the present disclosure are not limited to the effects mentioned above, and other effects not mentioned will be clearly understood by those skilled in the art from the description below.

In addition to the above effects, specific effects of the present disclosure are described together while describing specific details for carrying out the present disclosure.

### BRIEF DESCRIPTION OF DRAWINGS

FIG. 1 is a perspective view of a secondary battery module according to an embodiment of the present disclosure.

FIG. 2 is a plan view of a secondary battery module according to an embodiment of the present disclosure.

FIG. 3 is a partial exploded view of a secondary battery module according to one embodiment of the present disclosure.

FIG. 4 is a front view of a busbar according to an embodiment of the present disclosure.

FIG. 5 is an exploded view of a layer of a secondary battery module according to one embodiment of the present disclosure.

FIG. 6 is a cross-sectional view of a layer of a secondary battery module according to one embodiment of the present disclosure.

FIG. 7 is a perspective view of a secondary battery according to an embodiment of the present disclosure.

FIG. 8 is a plan view of a secondary battery according to an embodiment of the present disclosure.

FIG. 9 is a diagram showing flow of current in a busbar of a secondary battery module according to an embodiment of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be embodied in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be embodied differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “beneath,” “below,” “lower,” “under,” “above,” “upper,” and the like, may be used herein for ease of explanation to describe one element or feature's relationship to another element or feature as illustrated in the figures. It will be understood that the spatially relative terms are intended to encompass different orientations of the device in use or in operation, in addition to the orientation depicted in the figures. For example, when the device in the drawings may be turned over, elements described as “below” or “beneath” or “under” other elements or features would then be oriented “above” the other elements or features. Thus, the example terms “below” and “under” may encompass both an orientation of above and below. The device may be otherwise oriented for example, rotated 90 degrees or at other orientations, and the spatially relative descriptors used herein should be interpreted accordingly.

The features of the various embodiments of the present disclosure may be partially or entirely combined with each other, and may be technically associated with each other or operate with each other. The embodiments may be embodied independently of each other and may be embodied together in an association relationship.

In interpreting a numerical value, the value is interpreted as including an error range unless there is no separate explicit description thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description below have been selected as being general and universal in the related technical field. However, there may be other terms than the terms depending on the development and/or change of technology, convention, preference of technicians, etc. Therefore, the terms used in the description below should not be understood as limiting technical ideas, but should be understood as examples of the terms for illustrating embodiments.

Further, in a specific case, a term may be arbitrarily selected by the applicant, and in this case, the detailed meaning thereof will be described in a corresponding description section. Therefore, the terms used in the description below should be understood based on not simply the name of the terms, but the meaning of the terms and the contents throughout the Detailed Descriptions.

Hereinafter, the present disclosure will be described with reference to drawings for illustrating a secondary battery module and a secondary battery including the same according to embodiments of the present disclosure.

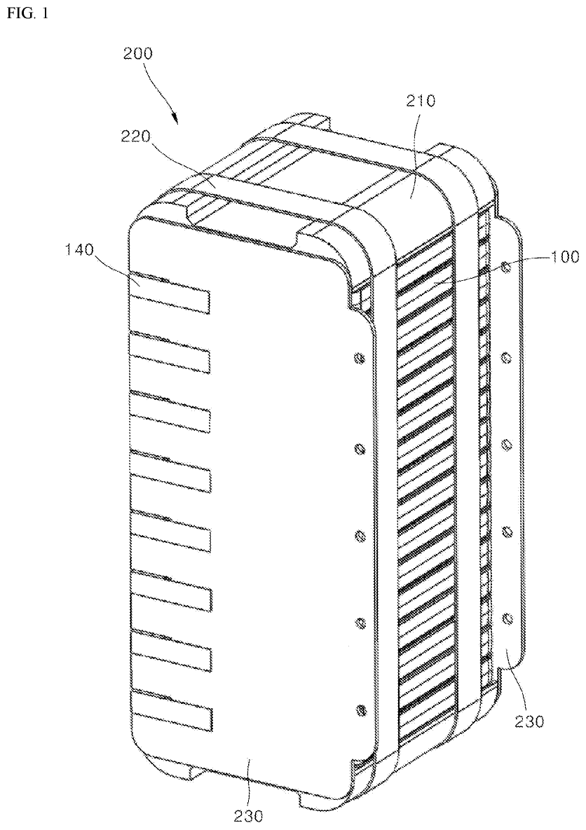

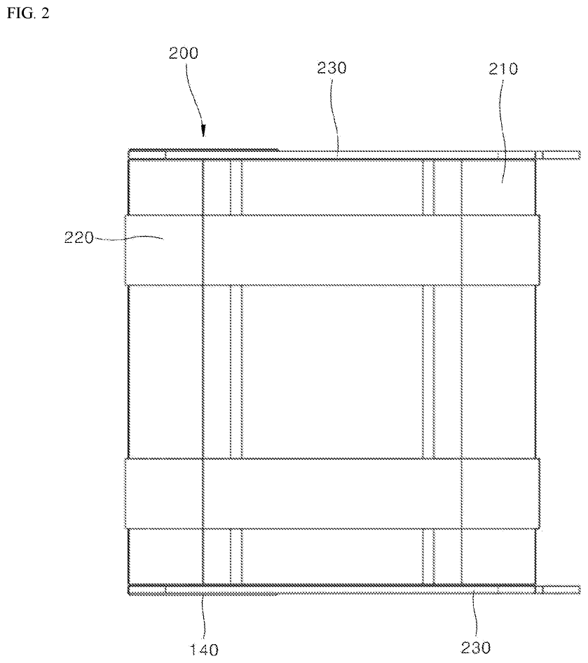

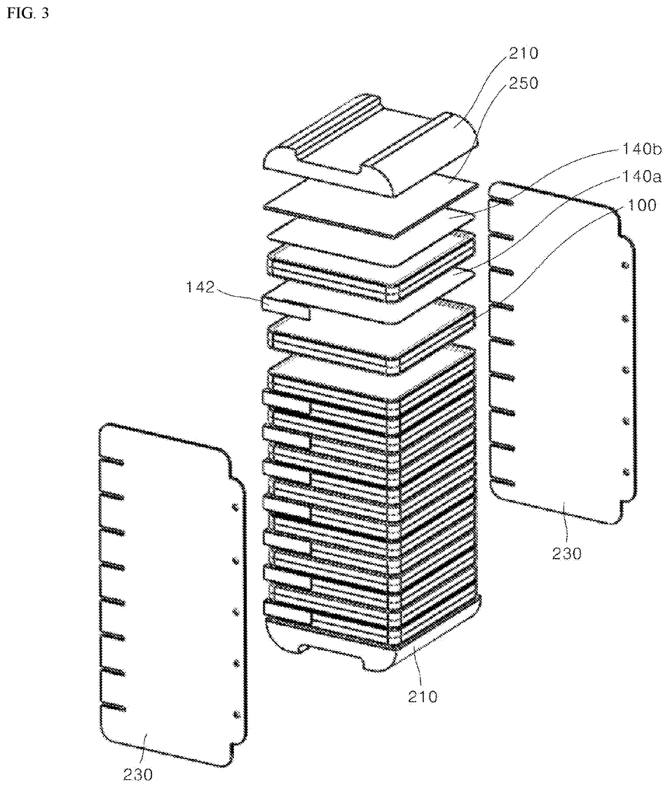

FIG. 1 is a perspective view of a secondary battery module according to an embodiment of the present disclosure. FIG. 2 is a plan view of a secondary battery module according to an embodiment of the present disclosure. FIG. 3 is a partial exploded view of the secondary battery module according to one embodiment of the present disclosure.

A secondary battery module 200 according to an embodiment of the present disclosure includes a stack of a plurality of layers 100 in which an oxidation-reduction reaction occurs and which are stacked in one direction, a pair of busbars 230 respectively disposed on both opposing side surfaces of the stack of the plurality of layers 100 and connecting the plurality of layers to each other in a parallel manner, a pair of end plates 210 respectively disposed on both opposing ends of the stack in the stacking direction of the plurality of layers 100, and a band 220 that surrounds and fastens the pair of end plates 210 and the plurality of layers 100.

The secondary battery module 200 has a rectangular parallelepiped shape extending in an elongate manner in the stacking direction of the plurality of layers 100 (that is, in a height direction).

In the layer 100, redox couples dissolved in the electrolyte undergo the redox reaction and accumulate or release electrical energy therein. The layer 100 has a rectangular parallelepiped shape having a small height. The plurality of layers 100 are stacked in the height direction. It is preferable that the stack of the plurality of layers 100 stacked in the height direction has a rectangular parallelepiped shape extending in an elongate manner in the height direction.

The pair of end plates 210 are respectively disposed on both opposing ends in the height direction of the stack of the plurality of layers 100. Each of the pair of end plates 210 has a roughly rectangular parallelepiped shape having a small height. The end plate 210 has a base and both opposing portions around the base on which the band 220 is disposed. The both opposing portions of the end plate 210 contacting the band 220 are rounded. The end plate 210 has both opposing side surfaces respectively contacting the pair of busbars 230. The both opposing side surfaces of the endplate is flat. The end plate 210 may be made of a high-strength inorganic compound material, or may be made of a concrete including a cement, sands, admixtures, glass fibers, and fillers.

A pair of insulating plates 250 may be disposed between the stack of the plurality of layers 100 and the pair of end plates 210, respectively. Each of the pair of insulating plates 250 may be preferably made of a non-conductive material with high strength, excellent heat resistance and chemical resistance. In this embodiment, each of the pair of insulating plates 250 may be made of an acryl-based resin.

The plurality of layers 100 and the pair of end plates 210 are fastened to each other using the band 220. The band 220 surrounds and fastens the pair of end plates 210 and the plurality of layers 100. The band 220 is formed in a ring shape and is positioned to surround the bases and the both opposing portions of the pair of end plates 210 and side surfaces of the stack of the plurality of layers 100. The band 220 is disposed on both opposing side surfaces of the stack of the plurality of layers 100 on which the pair of busbars 230 are not disposed, respectively. The band 220 physically fastens the plurality of layers 100 and the pair of end plates 210 to each other. The band 220 is made of PP (polypropylene) or PET (polyethylene terephthalate), which has low elasticity, non-conductivity, and excellent heat and chemical resistances.

The band 220 may include a plurality of bands. The plurality of bands 220 are spaced apart from each other and arranged in a parallel manner to each other and surround and fasten the pair of end plates 210 and the plurality of layers 100 in the same surrounding direction.

The pair of busbars 230 connect the plurality of layers 100 to each other in a parallel manner to each other. One of the pair of busbars 230 electrically connects some of a plurality of metal current collectors 140 through which electrons migrate under the redox reaction to each other, while the other thereof electrically connects the others of the plurality of metal current collectors 140 through which electrons migrate under the redox reaction to each other. Referring to FIG. 3, one of the pair of busbars 230 electrically connects a plurality of first metal current collectors 140a to each other, while the other thereof electrically connects a plurality of second metal current collectors 140b to each other. Each of the pair of busbar 230 is fitted with a plurality of protrusions 142 respectively protruding from side surfaces of the plurality of metal current collectors 140 corresponding to the plurality of layers 100 and are bonded to the plurality of protrusions 142.

The pair of busbars 230 are respectively disposed on both opposing side surfaces of the stack of the plurality of layers 100. The pair of busbars 230 are respectively disposed on both opposing side surfaces of the stack of the plurality of layers 100 on which the band 220 is not disposed. The pair of busbars 230 are respectively disposed on both opposing side surfaces of the stack of the plurality of layers 100 along which the protrusions 142 of the plurality of metal current collectors 140 are arranged. The pair of busbars 230 are disposed on both opposing side surfaces of each of a pair of end plates 210, respectively. Each of the pair of busbars 230 may have an insulator attached or applied to a side surface thereof facing the side surface of the stack of the plurality of layers 100. The insulator attached or applied to each of the side surface of each of the pair of busbars 230 insulates each of the pair of busbars 230 and the stack of the plurality of layers 100 from each other. Furthermore, a first liquid electrode or a second liquid electrode leaking from the plurality of layers 100 may flow down along and on the insulator.

Each of the pair of busbars 230 has a roughly rectangular plate shape extending in an elongate manner in the stacking direction of plurality of layers 100 (in the height direction). The busbar 230 entirely covers the side surface of the stack of the plurality of layers 100 on which the busbar 230 is disposed. A vertical length of busbar 230 is larger than a vertical length of the stack of the plurality of layers 100. A largest width of the busbar 230 is larger than a width of the side surface of the stack of the plurality of layers 100 on which the busbar 230 is disposed. An area size of the side surface of the busbar 230 is larger than an area size of the side surface of the stack of the plurality of layers 100 on which the busbar 230 is disposed. A top and a bottom of the busbar 230 are in contact with the pair of end plates 210, respectively. A vertical level of the top of the busbar 230 is lower than that of a top of the end plate 210 disposed on top of the stack of the plurality of layers 100, while a vertical level of the bottom thereof is higher than that of a bottom of the end plate 210 disposed under the stack of the plurality of layers 100.

When a plurality of secondary battery modules 200 are arranged densely in the horizontal direction, one of the pair of busbars 230 of the secondary battery module 200 is electrically connected to one of the pair of busbars 230 of the secondary battery module 200 adjacent thereto such that the adjacent two secondary battery modules 200 are electrically connected to each other in a series manner.

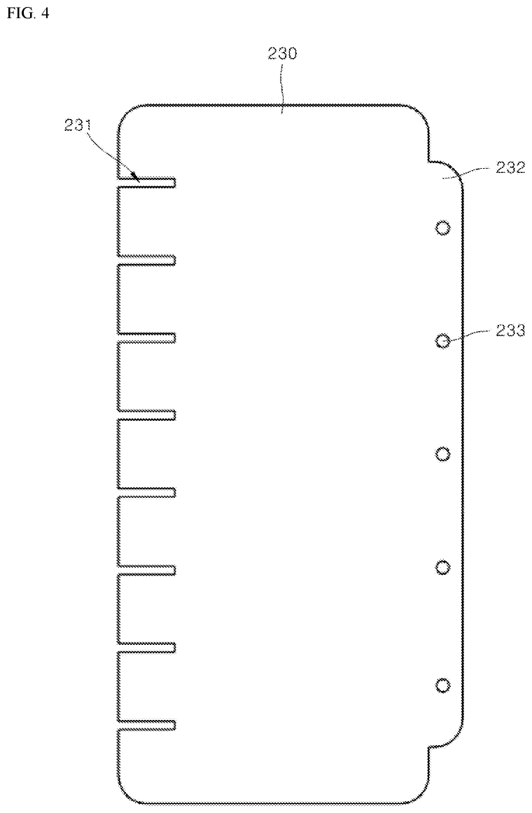

FIG. 4 is a front view of a busbar according to an embodiment of the present disclosure.

The busbar 230 has a plurality of busbar slits 231 into which the portions of the plurality of metal current collectors 140 are inserted, respectively. The plurality of busbar slits 231 are arranged in the height direction of the stack of the plurality of layers 100. The busbar slit 231 is formed at one side of the busbar 230 and extends in a direction perpendicular to the stacking direction of the plurality of layers 100 (in the horizontal direction). It is desirable that each of widths of the busbar slits 231 may be equal to a thickness of the protrusion of each of the metal current collectors 140 or may be larger than the thickness of the protrusion of each of the metal current collectors 140. The protrusion 142 of the metal current collector 140 is inserted into the busbar slit 231. The protrusion 142 inserted into the busbar slit 231 is bent along a bent line as a connection line between the protrusion and the silt such that the protrusion 142 faces and contacts the busbar 230. The protrusion is joined to the busbar 230 via spot welding. Referring to FIG. 2, the protrusions 142 are sequentially and vertically arranged and disposed on the side surface of the stack of the plurality of layers 10.

The busbar 230 is formed to have a busbar wing 232. The wing 232 may be formed by protruding a side portion of the busbar beyond the side surface of the stack of the plurality of layers 100. That is, in the busbar 230, the plurality of busbar slit 231 are formed in one of both opposing side ends, while the busbar wing 232 constitutes the other thereof. The busbar wing 232 protrudes outwardly beyond the side surface of the stack of the plurality of layers 100 and serves as a heat dissipation fin through which heat generated from the busbar 230 and/or the plurality of layers 100 is heat exchanged with air.

The busbar 230 is formed to have a plurality of busbar fastening holes 233 defined therein for fastening the busbar wing 232 using bolts. The plurality of busbar fastening holes 233 are arranged in the height direction of the plurality of layers 100. The plurality of busbar fastening hole 233 are spaced apart from the plurality of busbar slit 231 in the horizontal direction.

In the busbar 230, a vertical dimension of busbar wing 232 is substantially equal to a vertical dimension of a vertical area where the plurality of busbar slits 231 are formed and arranged. In the busbar 230, the busbar wing 232 positionally correspond to the arrangement of the plurality of busbar slits 231 the horizontal direction. In the busbar 230, a vertical length of the busbar wing 232 is smaller than that of the stack of the plurality of layers 100. The plurality of busbar slits 231 is spaced apart from the plurality of busbar fastening holes 233 in the horizontal direction.

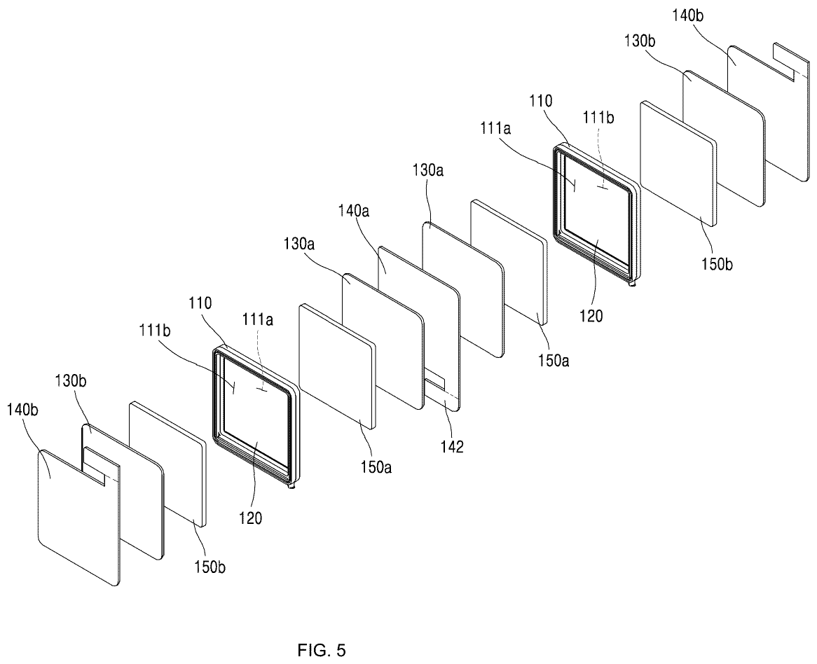

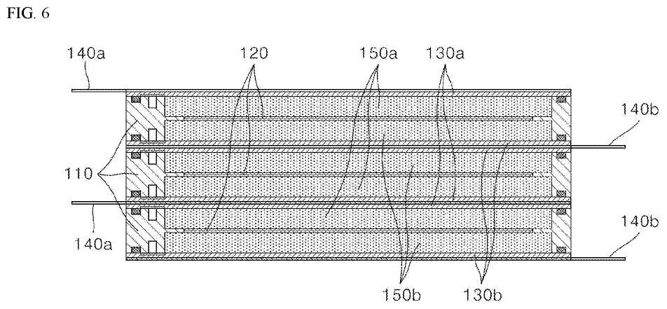

FIG. 5 is an exploded view of a layer of a secondary battery module according to an embodiment of the present disclosure, and FIG. 6 is a cross-sectional view of a layer of a secondary battery module according to an embodiment of the present disclosure.

The layer 100 includes a first liquid electrode where a first half reaction occurs, a second liquid electrode where a second half reaction occurs, a first electrode reservoir 111a as a space where the first liquid electrode is stored, a second electrode reservoir 111b as a space in which the second liquid electrode is stored, a hollow frame 110 having the first electrode reservoir 111a and the second electrode reservoir 111b defined therein, a separator 120 coupled to the frame 110 and disposed between the first electrode reservoir 111a and the second electrode reservoir 111b, a first carbon current collector 130a in contact with the first electrode reservoir 111a of the frame 110 and electrically connected to the first liquid electrode, a second carbon current collector 130b that is in contact with the second electrode reservoir 111b of the frame 110 and is electrically connected to the second liquid electrode, a first metal current collector 140a which is in contact with the first carbon current collector 130a and electrically connected to the first carbon current collector 130a, a second metal current collector 140b which is in contact with the second carbon current collector 130b and is electrically connected to the second carbon current collector 130b, a first solid electrode 150a disposed in the first electrode reservoir 111a and impregnated with the first liquid electrode, and a second solid electrode 150b disposed in the second electrode reservoir 111b and impregnated with the second liquid electrode.

The first liquid electrode is an electrolyte in which an anode redox couple is dissolved. The anode redox couple may include at least one of vanadium (V), zinc (Zn), bromine (Br), chromium (Cr), manganese (Mn), titanium (Ti), iron (Fe), cerium (Ce), and cobalt (Co). In this embodiment, the anode redox couple is a V²⁺/V³⁺ redox couple. The first liquid electrode may be an acidic aqueous solution as a solution which conducts electric current via ionization. Preferably, the acidic aqueous solution includes sulfuric acid. In this embodiment, the first liquid electrode may be prepared by dissolving VOSO₄ (vanadylsulfate) or V₂O₅ (vanadium pentoxide) in H₂SO₄ aqueous solution.

In the first liquid electrode, the first half reaction occurs. The first half reaction is as follows:

$${V}^{2 +} \text{←→} {V}^{3 +} + {e}^{-}$$

where → represents a discharge reaction direction and ← represents a charge reaction direction.

In a discharging operation, vanadium ions are oxidized to vanadium trivalent ions. In a charging operation, vanadium trivalent ions are reduced to vanadium divalent ions.

The first liquid electrode is surrounded with the frame 110, the first carbon current collector 130a, and the separator 120. The first liquid electrode is impregnated into the first solid electrode 150a and stored in the first electrode reservoir 111a.

The first liquid electrode is electrically connected to the first carbon current collector 130a. In discharging, electrons therefrom migrate to the first carbon current collector 130a, while in charging, electrons from the first carbon current collector 130a migrate to the first liquid electrode. The first liquid electrode is in contact with the separator 120, such that hydrogen cations (protons) therefrom are transferred through the separator 120.

In the second liquid electrode, the second half reaction occurs. The second half reaction is as follows:

$${V}^{5 +} + {e}^{-} \text{←→} {V}^{4 +}$$

where → represents a discharge reaction direction and ← represents a charge reaction direction.

In a discharging operation, vanadium pentavalent ions are reduced to vanadium tetravalent ions. In a charging operation, vanadium tetravalent ions are oxidized to vanadium pentavalent ions.

The second liquid electrode is surrounded with the frame 110, the second carbon current collector 130b, and the separator 120.

The second liquid electrode is impregnated into the second solid electrode 150b and stored in the second electrode reservoir 111b.

The second liquid electrode is electrically connected to the second carbon current collector 130b. Thus, in charging, electrons migrate from the second liquid electrode to the second carbon current collector 130b, while in discharging, electrons from the second carbon current collector 130b migrate to the second liquid electrode. The second liquid electrode is in contact with the separator 120, such that hydrogen cations (protons) are transferred through the separator 120.

As described above, the first liquid electrode and the second liquid electrode include the same ingredient. The first liquid electrode and the second liquid electrode are made of the same electrolyte containing vanadium ions. In manufacturing the secondary battery, when the electrolyte in which 3.5 valent vanadium ions (V^{3.5+}) is dissolved is injected into the first electrode reservoir 111a and the second electrode reservoir 111b, the liquid electrode introduced into the first electrode reservoir 111a becomes the first liquid electrode, while the liquid electrode flowing into second electrode reservoir 111b becomes the second liquid electrode.

The frame 110 is formed as a hollow cube. The frame 110 preferably has a rectangular parallelepiped shape with a small height with open upper and lower surfaces. Depending on an embodiment, the frame 110 may be formed as a polyhedron of various shapes. The frame 110 has the first electrode reservoir 111a and the second electrode reservoir 111b defined therein.

The frame 110 has a hollow space divided into the first electrode reservoir 111a and the second electrode reservoir 111b via the separator 120. The separator 120 are coupled to the frame 110 and are arranged in the stacking direction of the plurality of layers 100 (in the height direction). The frame 110 supports the separators 120.

In the frame 110, the first carbon current collector 130a is disposed at one side in the height direction, and the second carbon current collector 130b is disposed at the other side in the height direction. The hollow space of the frame 110 is closed by the first carbon current collector 130a and the second carbon current collector 130b. The frame 110 defines the first electrode reservoir 111a between the first carbon current collector 130a and the separator 120, while the frame 110 defines the second electrode reservoir 111b between the second carbon current collector 130b and the separator 120. The frame 110 accommodates therein the first liquid electrode and the second liquid electrode. The first solid electrode 150a and the second solid electrode 150b are disposed inside the hollow space of the frame 110.

The separator 120 is disposed in the hollow space of the frame 110 so as to separate the first liquid electrode and the second liquid electrode from each other and allow hydrogen cation (protons) to be transferred between the first liquid electrode and the second liquid electrode therethrough. The separator 120 is disposed in the hollow space of the frame 110 and distinguishes the first electrode reservoir 111a and the second electrode reservoir 111b from each other. The separator 120 is disposed between the first carbon current collector 130a and the second carbon current collector 130b. The separator 120 is joined, at both opposing side edges, to the frame 110. Hydrogen cations migrate from the first liquid electrode to the second liquid electrode through the separator 120 during discharging, while the hydrogen cations migrate from the second liquid electrode to the first liquid electrode through the separator 120 during charging.

The separator 120 may include perfluorinated ionomer, partially fluorinated polymer, and non-fluorinated hydrocarbon. The separator 120 may be made of or include Nafion®, Flemion™, NEOSEPTA-F®, or Gore Select®.

The first carbon current collector 130a is disposed at one side of the frame 110 in the height direction and defines the first electrode reservoir 111a together with the frame 110 and the separator 120. The first carbon current collector 130a is electrically connected to the first liquid electrode, and electrons migrate therethrough during charging and discharging.

The first carbon current collector 130a is made of a material such as graphite, carbon, and carbon plastic, and has high electrical conductivity and high acid resistance. The first carbon current collector 130a is disposed between the first liquid electrode and the first metal current collector 140a to allow electron transfer therebetween therethrough, but prevents the first metal current collector 140a from being oxidized by the liquid electrode.

When the plurality of layers 100 are stacked, respective two first carbon current collectors 130a of two adjacent layers 100 are disposed adjacent to each other. One first metal current collector 140a is disposed between two adjacent first carbon current collectors 130a.

The second carbon current collector 130b is disposed at the other side of the frame 110 in the height direction and defines the second electrode reservoir 111b together with the frame 110 and the separator 120. The second carbon current collector 130b is electrically connected to the second liquid electrode, and electrons migrate therethrough during charging and discharging.

The second carbon current collector 130b is made of a material such as graphite, carbon, and carbon plastic, and has high electrical conductivity and high acid resistance. The second carbon current collector 130b is disposed between the second liquid electrode and the second metal current collector 140b to allow electron transfer therebetween therethrough, but prevents the second metal current collector 140b from being oxidized by the liquid electrode.

When the plurality of layers 100 are stacked, respective two second carbon current collectors 130b of two adjacent layers 100 are disposed adjacent to each other. One second metal current collector 140b is disposed between the two adjacent second carbon current collectors 130b.

The first metal current collector 140a is made of a metal with high electrical conductivity, such as copper or aluminum. The first metal current collector 140a may be formed as a flexible thin film or as a rigid plate. The first metal current collector 140a is formed in a shape of a rectangular plate, and has the protrusion 142 that partially protrudes therefrom and beyond the surface side of the frame 110. The protrusion 142 of the first metal current collector 140a may be joined to the busbar 230 by the spot welding and may be electrically connected to the busbar 230.

The first metal current collector 140a is in surface contact with the first carbon current collector 130a and is electrically connected thereto. Electrons migrate to the first metal current collector 140a under the redox reaction of the first liquid electrode and thus current flows in the first metal current collector 140a.

The first metal current collector 140a is disposed between two adjacent first carbon current collectors 130a or between the first carbon current collector 130a and the end plate 210 (or the insulating plate 250). When the plurality of layers 100 are stacked, two adjacent layers 100 share one first metal current collector 140a.

The second metal current collector 140b is made of a metal with high electrical conductivity, such as copper or aluminum. The second metal current collector 140b may be formed as a flexible thin film or as a rigid plate. The second metal current collector 140b is formed in a shape of a rectangular plate, and has the protrusion 142 that partially protrudes therefrom and beyond the surface side of the frame 110. The protrusion 142 of the second metal current collector 140b may be joined to the busbar 230 by the spot welding and may be electrically connected to the busbar 230.

The second metal current collector 140b is in surface contact with the second carbon current collector 130b and is electrically connected thereto. Electrons migrate to the second metal current collector 140b under the redox reaction of the first liquid electrode and thus current flows in the second metal current collector 140b.

The second metal current collector 140b is disposed between two adjacent second carbon current collectors 130b or between the second carbon current collector 130b and the end plate 210 (or the insulating plate 250). When the plurality of layers 100 are stacked, two adjacent layers 100 share one second metal current collector 140b.

The first metal current collector 140a and the second metal current collector 140b as described above are made of the same material and have the same shape, and thus are collectively referred to as a metal current collector 140. Among a plurality of metal current collectors 140, one in contact with the first carbon current collector 130a becomes the first metal current collector 140a, while one in contact with the second carbon current collector 130b becomes the second metal current collector 140b. Each of the first metal current collector 140a and the second metal current collector 140b of the same shape has the protrusion 142 protruding therefrom and beyond both opposing side surfaces of the frame 110.

The protrusion 142 of the metal current collector 140 is formed in an “L” shape, and a narrow portion thereof is inserted into the busbar slit 231. The protrusion 142 is bent along the narrow portion inserted into the busbar slit 231 as a bent line such that a wide portion thereof faces and is in contact with the busbar 230.

When the plurality of layers 100 are stacked, two adjacent layers 100 share one metal current collector 140. When the plurality of layers 100 are stacked, one of the plurality of metal current collectors 140 is disposed between the two adjacent first carbon current collectors 130a, while one thereof is disposed between the two adjacent second carbon current collectors 130b.

The first solid electrode 150a is impregnated with the first liquid electrode and disposed in the first electrode reservoir 111a. The first solid electrode 150a is surrounded with the frame 110, the first carbon current collector 130a, and the separator 120. The first solid electrode 150a includes carbon-based materials such as carbon or graphite felt, carbon cloth, carbon black, graphite powder or graphene. The first solid electrode 150a may be porous and formed in a rectangular parallelepiped shape. The first solid electrode 150a may have a thickness greater than a height direction thickness of the first electrode reservoir 111a, and in this case, the first solid electrode 150a may be compressed and accommodated in the first electrode reservoir 111a. The first solid electrode 150a is in close contact with the first carbon current collector 130a and the separator 120.

The second solid electrode 150b is impregnated with the second liquid electrode and disposed in the second electrode reservoir 111b. The second solid electrode 150b is surrounded with the frame 110, the second carbon current collector 130b, and the separator 120. The second solid electrode 150b includes a carbon-based material such as carbon or graphite felt, carbon cloth, carbon black, graphite powder or graphene. The second solid electrode 150b may be porous and formed in a rectangular parallelepiped shape. The second solid electrode 150b may have a thickness greater than a height direction thickness of the second electrode reservoir 111b, and in this case, the second solid electrode 150b may be compressed and accommodated into the second electrode reservoir 111b. The second solid electrode 150b is in close contact with the second carbon current collector 130b and the separator 120.

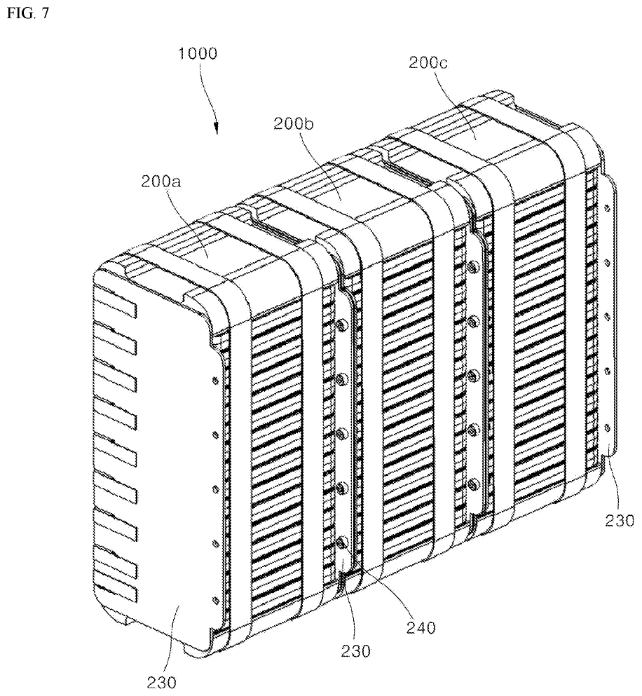

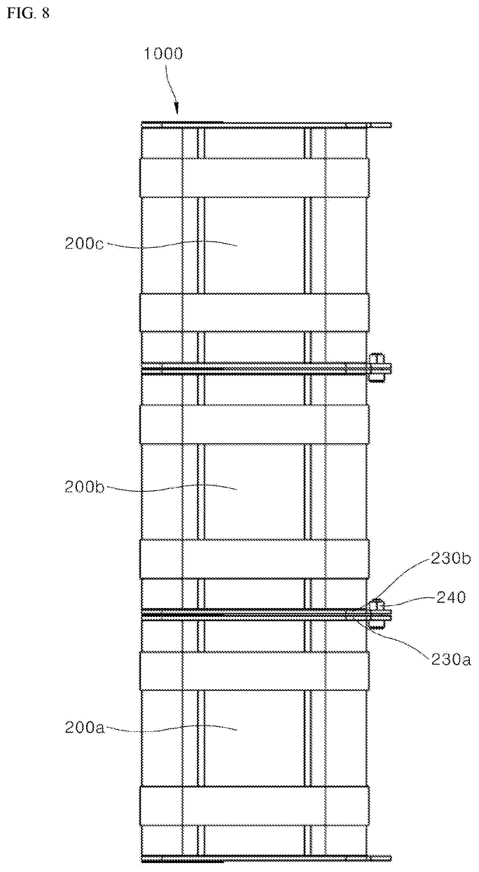

FIG. 7 is a perspective view of a secondary battery according to an embodiment of the present disclosure, and FIG. 8 is a plan view of a secondary battery according to an embodiment of the present disclosure.

The secondary battery 1000 according to an embodiment of the present disclosure include a plurality of secondary battery modules 200 arranged densely in one direction, and a plurality of busbar connections 240 for connecting two adjacent secondary battery modules 200 of the plurality of secondary battery modules 200 in a series manner.

In the secondary battery 1000, two or more secondary battery modules 200 are densely arranged in a horizontal direction (a direction perpendicular to the stacking direction of the plurality of layers 100). In this embodiment, three secondary battery modules 200 are arranged in the horizontal direction. In this embodiment, the plurality of secondary battery modules 200 include a first secondary battery module 200a, a second secondary battery module 200b, and a third secondary battery module 200c.

Two adjacent secondary battery modules 200 are connected to each other in series. The respective busbars 230 of the two adjacent secondary battery modules 200 are electrically connected to each other. In this embodiment, a busbar 230a of the first secondary battery module 200a and a busbar 230b of the second secondary battery module 200b are electrically connected to each other. The respective busbars 230 of the two adjacent secondary battery modules 200 partially protrude outwardly beyond the side surface of the stack of the plurality of layers 100 such that the protrusions thereof are connected to each other. In this embodiment, the busbar 230a of the first secondary battery module 200a and the busbar 230b of the second secondary battery module 200b partially protrude outwardly beyond the side surface of the stack of the plurality of layers 100 such that the protrusions thereof are connected to each other.

The plurality of busbar connections 240 is disposed on the busbar wing 232 of the busbar 230. The plurality of busbar connections 240 is disposed on the busbar wing 232 that protrudes outwardly beyond the side surface of the stack of the plurality of layers 100 and may be easily attached and detached from the busbar 230. This makes assembly and maintenance easy.

The plurality of busbar connections 240 electrically and physically connects the respective busbar wings 232 of the respective busbars 230 of the two adjacent secondary battery modules 200 to each other, thereby electrically connecting the two adjacent secondary battery modules 200 to each other in a series manner. In this embodiment, the plurality of busbar connections 240 electrically and physically connects the busbar wing 232 of the busbar 230a of the first secondary battery module 200a and the busbar wing 232 of the busbar 230b of the second secondary battery module 200b to each other, thereby electrically connecting the first secondary battery module 200a and the second secondary battery module 200b to each other in the series manner.

The plurality of busbar connections 240 may be embodied as a variety of structures such as a welding portion, wires, bolts, and clips that electrically and physically connect the two busbars 230 to each other. In this embodiment, the plurality of busbar connections 240 may include bolts and nuts for fastening the two busbars 230 to each other. The plurality of busbar connections 240 respectively pass through the busbar fastening holes 233 of the busbar 230 in a direction in which the plurality of secondary battery modules 200 are arranged.

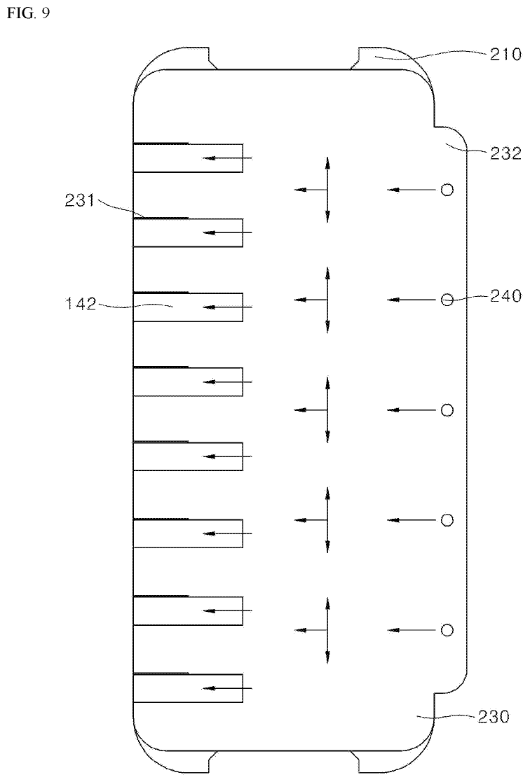

FIG. 9 is a diagram showing flow of current in the busbar of the secondary battery module according to an embodiment of the present disclosure.

In charging the secondary battery module 200, the current flowing from an external power source flows to the busbar 230 through the plurality of busbar connections 240 of the secondary battery 1000. Since the protrusions 142 of the plurality of metal current collectors 140 positionally correspond to the plurality of busbar connections 240 in the horizontal direction, the current flows horizontally from the plurality of busbar connections 240 toward the protrusions 142 of the plurality of metal current collector 140, respectively.

There may be a deviation between the currents flowing into the plurality of layers 100 through the protrusions 142 of the plurality of metal current collectors 140, respectively. For this reason, the protrusions 142 of the plurality of metal current collectors 140 and the plurality of busbar connections 240 may be spaced apart from each other in the horizontal direction, respectively, such that a path where the currents can flow in the stacking direction of the plurality of layers 100 (in the vertical direction) is created to cancel off the deviation. Accordingly, the currents flowing from the plurality of busbar connections 240 to the busbars 230, respectively may be balanced out while flowing in the vertical direction. Thus, the uniform currents may flow to the protrusions 142 of the plurality of metal current collectors 140.

As described above, the protrusions 142 of the plurality of metal current collector 140 positionally corresponds to the plurality of busbar connections 240 in the horizontal direction and are spaced apart from the plurality of busbar connections 240 in the horizontal direction. That is, a vertical arrangement of the plurality of busbar slits 231 positionally corresponds, in the horizontal direction, to the busbar wing 232 in which the vertical arrangement of the plurality of busbar fastening holes 233 is formed, and is spaced apart from the busbar wing 232 in the horizontal direction. Thus, the current may flow through an entire area of the busbar 230. As a result, the resistance is reduced, thereby increasing energy efficiency and reducing heat generation.

Although the embodiments of the present disclosure have been described in more detail with reference to the accompanying drawings, the present disclosure is not necessarily limited to the embodiments, and may be modified in a various manner in the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects.

What is claimed is:

1. A secondary battery module comprising:
a stack of a plurality of layers arranged along a stacking direction, wherein each layer is configured to accommodate a redox reaction therein; and
a pair of busbars respectively disposed on opposite lateral side surfaces of the stack of the plurality of layers so as to electrically connect the plurality of layers to each other in a parallel manner.

2. The secondary battery module of claim 1, wherein each layer of the plurality of layers includes a respective plurality of metal current collectors configured to allow migration of electrons under the redox reaction,
wherein a first busbar of the pair of busbars electrically connects a first set of metal current collectors to each other, among the plurality of metal current collectors,
wherein a second busbar of the pair of busbars electrically connects a second set of metal current collectors to each other, among the plurality of metal current collectors, and
wherein the first set does not include any metal current collectors among the second set.

3. The secondary battery module of claim 1, wherein each layer of the plurality of layers includes a respective plurality of metal current collectors configured to allow migration of electrons under the redox reaction,
wherein each busbar of the pair of busbars has a plurality of busbar slits defined therein into which portions of the plurality of metal current collectors are inserted, respectively.

4. The secondary battery module of claim 3, wherein the plurality of busbar slits are arranged along the stacking direction of the plurality of layers.

5. The secondary battery module of claim 3, wherein each metal current collector among the plurality of metal current collectors has a protrusion that protrudes outwardly beyond a lateral side surface of the stack of the plurality of layers,
wherein each protrusion is inserted into each busbar slit.

6. The secondary battery module of claim 5, wherein the protrusion is joined to the busbar.

7. The secondary battery module of claim 5, wherein an end portion of the protrusion is bent along a line of contact between the busbar slit and a middle portion of the protrusion such that the end portion of the protrusion faces and contacts an outer surface of the busbar.

8. The secondary battery module of claim 3, wherein each busbar of the pair of busbars has a busbar wing that protrudes beyond one lateral side surface of the stack of the plurality of layers,
wherein for each busbar, the plurality of busbar slits are formed along a first lateral end of the busbar, while the busbar wing protrudes from a second lateral end of the busbar that is opposite the first lateral end.

9. The secondary battery module of claim 8, wherein each busbar of the pair of busbars has a plurality of busbar fastening holes defined in the busbar wing for fastening the busbar using blots.

10. The secondary battery module of claim 8, wherein in each busbar of the pair of busbars, the busbar wing is arranged opposite to the plurality of busbar slits in a lateral direction that is perpendicular to the stacking direction of the plurality of layers.

11. The secondary battery module of claim 8, wherein in each busbar of the pair of busbars, a length of the busbar wing along the stacking direction is smaller than a length of the stack of the plurality of layers along the stacking direction.

12. The secondary battery module of claim 1, further comprising a pair of end plates respectively disposed on both opposing ends of the secondary battery module in the stacking direction of the plurality of layers,
wherein a top and a bottom of each busbar of the pair of busbars are respectively in contact with the pair of end plates.

13. The secondary battery module of claim 12, wherein each end plate of the pair of end plates comprises opposing lateral side surfaces on which the pair of busbars are disposed, respectively.

14. The secondary battery module of claim 12, wherein a an upper end of each busbar is positioned lower than an upper end of an upper end plate that is disposed on an upper end of the stack of the plurality of layers,
wherein a lower end of each busbar is positioned higher than a lower end of a lower end plate that is disposed under a lower end of the stack of the plurality of layers.

15. The secondary battery module of claim 1, further comprising a band that wraps around and fastens the stack of the plurality of layers,
wherein the band is disposed on both opposing lateral side surfaces of the stack of the plurality of layers on which the pair of busbars are not disposed.

16. The secondary battery module of claim 1, wherein each busbar of the pair of busbars has an insulator disposed on a surface of the busbar that faces a corresponding lateral side surface of the stack of the plurality of layers.

17. A secondary battery comprising:
a plurality of secondary battery modules arranged densely along a stacking direction,
wherein each secondary battery module of the plurality of secondary battery modules comprises:
a stack of a plurality of layers arranged along a stacking direction, wherein each layer is configured to accommodate a redox reaction therein;
a pair of busbars respectively disposed on opposite lateral side surfaces of the stack of the plurality of layers so as to electrically connect the plurality of layers to each other in a parallel manner,
wherein respective busbars of two adjacent secondary battery modules among the plurality of secondary battery modules are electrically connected to each other.

18. The secondary battery of claim 17, further comprising a plurality of busbar connections that electrically connect the two adjacent secondary battery modules among the plurality of secondary battery modules to each other in a series manner.

19. The secondary battery of claim 18, wherein each busbar of the pair of busbars has a busbar wing on one lateral side end thereof, wherein the busbar wing protrudes outwardly beyond a lateral side surface of the stack of the plurality of layers,
wherein the plurality of busbar connections physically and electrically connect respective busbar wings of respective busbars of the two adjacent secondary battery modules to each other.

20. The secondary battery of claim 19, wherein each busbar of the pair of busbars has a plurality of busbar fastening holes defined therein through which the plurality of busbar connections pass, respectively.
